(19) United States
(12) Patent Application Publication
(10) Pub. No.: US 2025/0269512 A1
(43) Pub. Date: Aug. 28, 2025

(54) BENCH DOG WITH T-SLOT

(71) Applicant: Samuel D. Henry, Elgin, IL (US)

(72) Inventor: Samuel D. Henry, Elgin, IL (US)

(73) Assignee: BAM IP Holding LLC, Saint Charles, IL (US)

(21) Appl. No.: 19/059,661

(22) Filed: Feb. 21, 2025

Related U.S. Application Data
(60) Provisional application No. 63/556,574, filed on Feb. 22, 2024.

(51) Int. Cl. B25H 1/14

(52) U.S. Cl. CPC B25H 1/14

(57) ABSTRACT

A bench dog adaptor has a body portion having an outer periphery extending between first and second ends. A longitudinal axis extending through the first and second ends. At least one of the first and second ends has a mounting slot extending along a first transverse axis that is generally perpendicular to the longitudinal axis. The mounting slot has a mouth region and spaced apart first and second undercut regions. A first width of the mouth region parallel to a second transverse axis is less than a second width parallel to the second transverse axis from the outer most extents of the first and second undercut regions. The second transverse axis is generally perpendicular to the first transverse axis. The bench dog adaptor includes at least one first mounting portion configured to resiliently radially engage a sidewall of a dog hole formed in a workbench to secure the body portion within the dog hole.

### CROSS-REFERENCE TO RELATED PATENT APPLICATIONS

This Patent Application claims the benefit of U.S. Provisional Patent Application No. 63/556,574, filed Feb. 22, 2024, the entire teachings and disclosure of which are incorporated herein by reference thereto.

### FIELD OF THE INVENTION

This invention generally relates to bench dogs for use with a workbench.

### BACKGROUND OF THE INVENTION

Many tools are used to secure and locate workpieces relative to a workbench. One particular tool is a bench dog. The bench dog is typically used to prevent movement of the workpiece in at least one direction (e.g. horizontally or vertically). They are often used when the jaws of a normal clamp are not of sufficient size to clamp or locate the workpiece.

The bench dog is typically located within a dog hole formed in the workpiece support surface of the workbench. Typically, the workbench will have an array of dog holes formed in the workpiece support surface so that the bench dog can be located at multiple different locations relative to the workbench, thus accommodating different sized and shaped workpieces.

Clamps or other alignment components may often be secured to the workbench using the dog holes. However, the portion of the tool that is inserted into the dog hole is typically tailored specific to the particular clamp or alignment component.

Some workbenches will incorporate T-tracks that have a T-shaped slot that can mount alignment components to the workbench using the T-tracks. While this can be useful, it requires the T-tracks to be installed in the workpiece support surface of the workbench. If no such T-track is provided in the workbench, then these workpiece alignment components cannot be used with the workbench.

### BRIEF SUMMARY OF THE INVENTION

Examples of the application provide new and improved bench dog adaptors that can be used to mount alignment components to a workbench that includes dog holes formed therein. In particular, the bench dog adaptor can be used to secure alignment components that may be otherwise mounted to a workbench that includes T-tracks to a workbench that does not have any such T-tracks.

In an example, a bench dog adaptor is provided. The bench dog adaptor has an elongated body portion having a first end a second end. The body portion has an outer periphery extending between the first and second ends. The body portion has a longitudinal axis extending through the first and second ends. At least one of the first and second ends has a mounting slot extending along a first transverse axis that is generally perpendicular to the longitudinal axis. The mounting slot has a mouth region and spaced apart first and second undercut regions. A first width of the mouth region parallel to a second transverse axis is less than a second width parallel to the second transverse axis from the outer most extents of the first and second undercut regions. The second transverse axis is generally perpendicular to the first transverse axis. The bench dog adaptor includes at least one first mounting portion configured to resiliently radially engage a sidewall of a dog hole formed in a workbench to secure the body portion within the dog hole.

In one example, the first mounting portion is a spring portion configured to resiliently flex radially inward towards the elongated body when inserted into a dog hole in a workbench.

In one example, the first mounting slot has a T-shaped cross-section.

In one example, the first and second undercut regions are formed by a continuous rectangular void portion having a generally rectangular profile. The mouth region is generally centered along the second transverse axis relative to the single continuous void. The mouth region is offset from the rectangular profile along the longitudinal axis. The mouth region and continuous rectangular void form a single continuous void.

In one example, the mouth region is a substantially rectangular void portion having a generally rectangular profile.

In one example, the mouth region is formed between spaced apart laterally inward extending first and second flange portions. The first flange portion is spaced apart from the second flange portion parallel to the second transverse axis. The first flange portion defines, in part, the first undercut region. The second flange portion defines, in part, the second undercut region.

In one example, the first and second flange portions have a cantilevered configuration.

In one example, the spring portion is formed as a continuous piece of material with the elongated body portion.

In one example, the mounting slot is formed at the first end. The spring portion has an elongated first wing portion that extends from a connection portion wherein the first wing portion is connected to the elongated body portion to a free end. The free end of the first wing portion is closer to the second end of the elongated body portion than the first end of the body portion along the longitudinal axis.

In one example, the free end is spaced radially outward from an outer periphery of the elongated body portion forming a radial gap therebetween.

In one example, the first wing portion includes a radially outward tapering outer surface that tapers radially outward from the longitudinal axis when moving along the longitudinal axis in a direction extending from the first end towards the second end.

In one example, the free end of the first wing portion is formed by a tapered region that extends radially inward towards the elongated body portion relative to a radially outer most extent of the radially outward tapering outer surface of the first wing portion.

In one example, a second mounting portion in the form of a second wing portion on an opposite side of the elongated body portion is provided that is substantially identical to the first wing portion.

In one example, the second wing portion is connected to the elongated body portion at a same axial location along the longitudinal axis as the first wing portion and a free end of the second wing portion is positioned at a same axial location long the longitudinal axis as the free end of the first wing portion.

In one example, the free ends of the first and second wing portions are resiliently flexible towards one another to allow for insertion into the dog hole and to provide radially outward directed engagement of the first and second wing portions with the dog hole or the wall defining the dog hole.

In one example, third and fourth mounting portions in the form of third and fourth wing portions are provided. The third and fourth wing portions are connected to the elongated body portion proximate the second end and extend towards the first end of the elongated body portion, terminating in free ends.

In one example, the first wing portion is angularly aligned about the longitudinal axis with the third wing portion and the second wing portion is angularly aligned about the longitudinal axis with the fourth wing portion.

In one example, the mounting slot is formed at the first end of the elongated body portion. The elongated body portion has a tubular portion extending axially between the first and second ends. The tubular portion is closed proximate the first end and open proximate the second end.

In one example, the free ends of the first and third wing portions are axially spaced apart from one another such that the entirety of the first wing portion is closer to the first end than the entirety of the third wing portion.

In one example, the outer periphery of the elongated body portion has alternating curved and flat regions angularly spaced around the longitudinal axis.

In one example, the outer periphery of the elongated body portion has alternating curved and flat regions angularly spaced around the longitudinal axis. The alternating curved and flat regions including at least first and second flat regions. The first and third wing portions angularly aligned with the first flat region and the second and fourth wing portions angularly aligned with the second flat region.

In one example, the tubular portion defines an internal cavity having a generally rectangular cross-section orthogonal to the longitudinal axis.

In one example, the internal cavity increases in cross-sectional area when moving from the first end towards the second end. The cross-sectional area is measured orthogonal to the longitudinal axis.

In one example, the radial engagement of the first mounting portion with the dog hole provides frictional engagement to resist removal of the elongated body portion from the dog hole.

In one example, the first and second wing portions extend parallel to the longitudinal axis a first length and the third and fourth wing portions extend parallel to the longitudinal axis a second length that is less than the first length.

In one example, fifth and sixth mounting portions in the form of fifth and sixth wing portions are included. The fifth and sixth wing portions re connected to the elongated body portion proximate the first end and extend towards the second end of the elongated body portion, terminating in free ends.

In one example, the fifth and sixth wing portions are angularly spaced apart about the longitudinal axis from each other and from the first and second wing portions.

In one example, the first, second, fifth and sixth wing portions extend axially parallel to the longitudinal axis a same length. In other examples, the first and second wing portions extend a same first length and the fifth and sixth wing portions extend a same second length that is different than the first length.

In one example, the elongated body portion is formed from a first body portion and a second body portion attached to the first body portion. The first and second wing portions are formed as a continuous piece of material with the first body portion and the fifth and sixth wing portions are formed as a continuous piece of material with the second body portion.

In one example, one of the first body portion or second body portion includes an attachment slot opening towards the first end and the other one of the first body portion or second body portion includes a mounting wall. The mounting wall extends into the attachment slot when the first and second body portions are attached to one another.

In one example, the outer periphery of the first body portion includes at least first, second, third and fourth flat regions angularly spaced around the longitudinal axis. The first wing portion is angularly aligned with the first flat region. The second wing portion is angularly aligned with the second flat region. The fifth wing portion is angularly aligned with the third flat region. The sixth wing portion is angularly aligned with the fourth flat region.

In one example, the first and second flat regions are angularly spaced on opposite side of the first body portion. The third and fourth flat regions are angularly spaced on opposite sides of the first body portion with the first flat region positioned angularly between the third and fourth flat regions and the second flat region positioned angularly between the third and fourth flat regions.

In one example, the second body portion has a first abutment and a second abutment. The first abutment faces the second abutment. The first abutment abuts the first flat region of the first body portion and the second abutment abuts the second flat region of the first body portion.

In one example, each of the first, second, third and fourth wing portions have an outward facing engagement surface configured to radially engage the sidewall of the dog hole when installed therein. A first maximum radial dimension measured perpendicular to the longitudinal axis to the engagement surface of the first and second wing portions is greater than a second maximum radial dimension measured perpendicular to the longitudinal axis to the engagement surface of the third and fourth wing portions, when the first, second, third and fourth wing portions are in a relaxed state.

In an example, a workbench workpiece alignment assembly for positioning a workpiece on a workbench is provided. The assembly includes a bench dog adaptor as outlined above. The assembly includes a workpiece alignment component. The alignment component includes a workpiece alignment member configured to engage a workpiece on the workbench. The alignment component includes an attachment member connected to the workpiece alignment member. The attachment member has a head configured to extend into undercut regions of the mounting slot of the bench dog adaptor and a shaft extending from the head that is sized to extend through the mouth region of the mounting slot to secure the workpiece alignment member to the bench dog adaptor.

The attachment member is removably attachable to the bench dog adaptor mounting slot.

In one example, the attachment member is a T-bolt.

In one example, the attachment member includes a cam member that has a released position and an engaged position. In the engaged position, the cam member applies a first amount of biasing force on the shaft and head such that the first end of the elongated body is biased against the workpiece alignment member with at least a first amount of biasing force. In the released position, the cam member applies no biasing force biasing the first end of the elongate body against the workpiece alignment member or a second amount of biasing force that is less than the first amount of biasing force.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partial perspective and cross-sectional illustration of a workbench having a plurality of bench dog adaptors installed therein with one adaptor mounting a workpiece alignment component to the workbench;

FIG. 2 is a perspective illustration of a first embodiment of a bench dog adaptor;

FIG. 3 is an exploded perspective illustration of the bench dog adaptor of FIG. 2;

FIG. 4 is a cross-sectional illustration of the bench dog adaptor of FIG. 2;

FIG. 5 is a cross-sectional illustration of the bench dog adaptor of FIG. 2 inserted into a work bench and securing an alignment component to the workbench;

FIG. 6 is a cross-sectional illustration of the bench dog adaptor of FIG. 2;

FIGS. 7-9 are illustrations of a further embodiment of a bench dog adaptor;

FIGS. 10-12 are perspective illustrations of a workpiece alignment component attached to a bench dog adaptor; and

FIGS. 13-15 are illustrations of a further embodiment of a bench dog adaptor.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

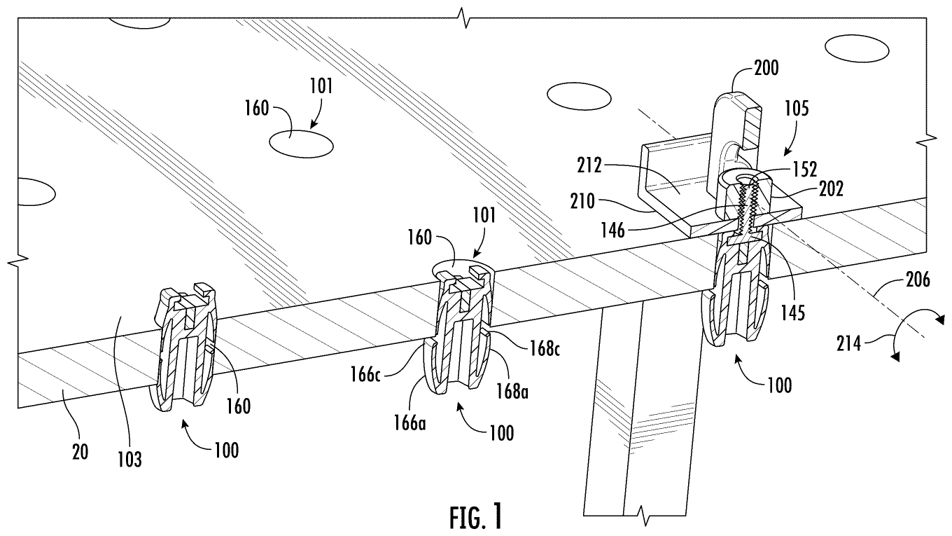

FIG. 1 is a partial illustration of a workbench 20 having a plurality of bench dog adaptors 100 installed in apertures 101 (also referred to as “dog holes 101”) formed in the worksurface 103 of the workbench 20. A workbench alignment component 105 is secured to the workbench 20 using a workbench bench dog adaptor. The workbench alignment component 105 takes the form of a stop member that can be used for abutting a side of a workpiece for locating the workpiece on the worksurface 103.

The bench dog adaptors 100 allow for different alignment components to use the dog holes 101 without requiring multiple such portions. Further, as will be illustrated below, the disclosed bench dog adaptors allow the use of alignment components that would otherwise work with T-tracks that are often installed in a work bench to be used on a workbench without any such T-tracks installed in the workpiece support surface (also referred to as the worksurface) of the workbench.

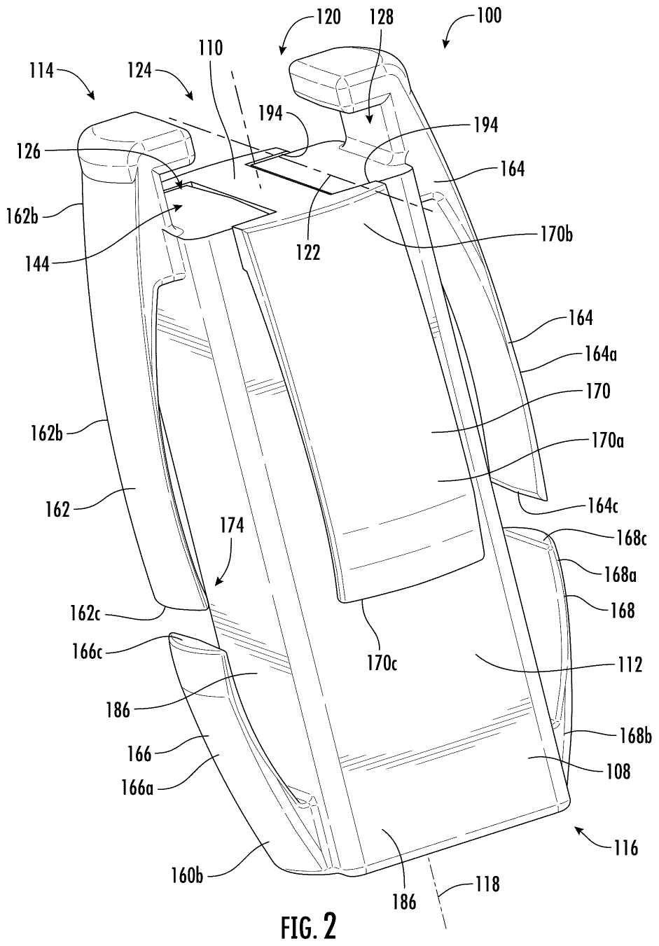

FIG. 2 illustrates a workbench bench dog adaptor 100. The bench dog adaptor 100 works with the workbench 20 and is mountable within the dog hole 101 formed in the worksurface 103 of the workbench 20. While the bench dog adaptor 100 can have numerous functions and can operate generally as a bench dog such as for being an abutment for locating a workpiece on the worksurface 103, in this example, the bench dog adaptor 100 is configured to mount devices, such as workpiece alignment components 105, to the workbench.

In particular, the bench dog adaptor 100 works with devices that have a T-bolt style connector to secure the devices to the workbench 20 and typically vertically above worksurface 103.

With reference to FIGS. 2-4, the bench dog adaptor 100, in this example, is a multi-piece construction formed from a first body portion 108 attached to a second body portion 110 that combine to form an elongated body portion 112.

The elongated body portion 112 has a first end 114 and a second end 116. A longitudinal axis 118 of the elongated body portion 112 extends through the first and second ends 114, 116. An outer periphery of the elongated body portion 112 extends between the first and second ends 114, 116.

The bench dog adaptor 100 includes a mounting slot 120 formed at the first end 114. However, in other examples, the bench dog adaptor 100 could have the mounting slot formed at the second end 116. Further yet, in other examples, the bench dog adaptor 100 could have a mounting slot at both the first end 114 and the second end 116.

In one example, the portions of the bench dog adaptor 100 that form the mounting slot 120 are sized smaller than a theoretical outer peripheral dimension of the bench dog adaptor 100. As such, in some embodiments, the portions of the bench dog adaptor that define the mounting slot 120 would not inhibit the bench dog adaptor from being pushed into and/or through the bench dog hole in the workbench 20.

The mounting slot 120 extend along a first transverse axis 122 that is generally perpendicular to longitudinal axis 118.

The mounting slot 120 has a mouth region 124 and first and second undercut regions 126, 128. The mouth region 124 has a first width W1 parallel to a second transverse axis 130 that is less than a second width W2 parallel to the second transverse axis 130 between the outer most extends of the first and second undercut regions 126, 128. Second width W2 may be measured between undercut walls 132, 134, which define the outer most extends of the first and second undercut regions 126, 128 in this example.

In this example, walls 132, 134 are generally parallel, but could be tapered relative to one another in other examples. Walls 132, 134 generally extend parallel to longitudinal axis 118 and first transverse axis 122 and are generally orthogonal to second transverse axis 130.

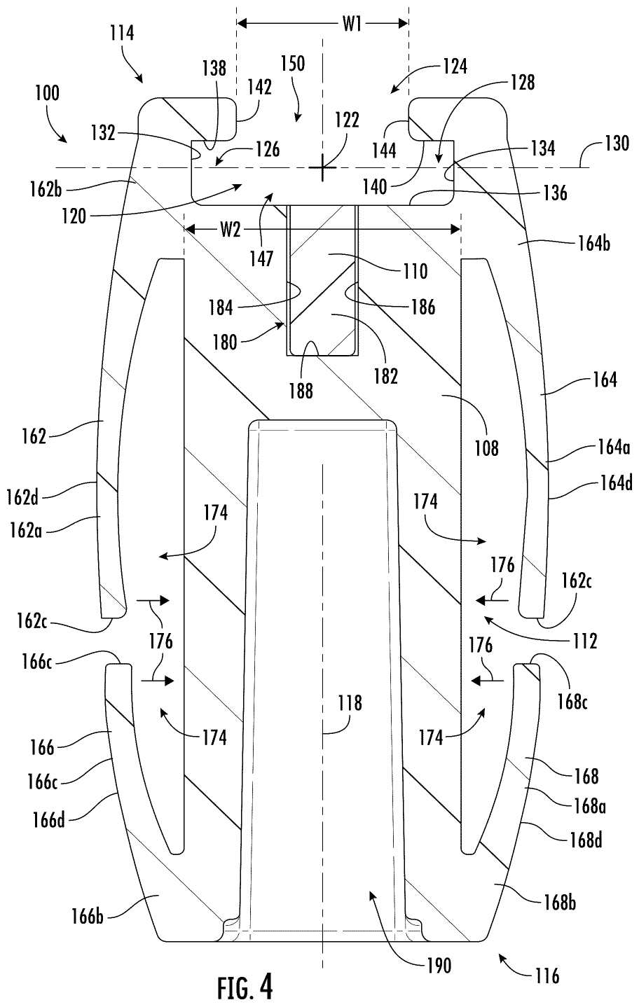

The due to the configuration of mouth region 124 and undercut regions 126, 128, the mounting slot 120 has a T-shaped cross-section when viewed down axis 122 as illustrated in FIG. 4. To form the T-shaped cross-section, in addition to walls 132, 134, the elongated body portion 112 includes bottom wall 136 retaining walls 138, 140 and mouth walls 142, 144.

Bottom wall 136 is spaced from retaining walls 138, 140 along axis 118 forming the undercut regions 126, 128 therebetween. Bottom wall 136 and retaining walls 138, 140 face one another. In this example, bottom wall 136 and retaining walls 138, 140 are generally parallel to one another with retaining walls 138, 140 being generally co-planar. However, other examples could have the retaining walls 138, 140 no parallel to one another, e.g. they could taper toward or away from first end 114 when moving laterally toward one another parallel to second transverse axis 130.

The undercut walls 132, 134, bottom wall 136, and retaining walls 138, 140 generally define a continuous rectangular void region 147 (also referred to as a head void region 147) that has a generally rectangular cross-sectional profile when viewed down the first transverse axis 122 in FIG. 4.

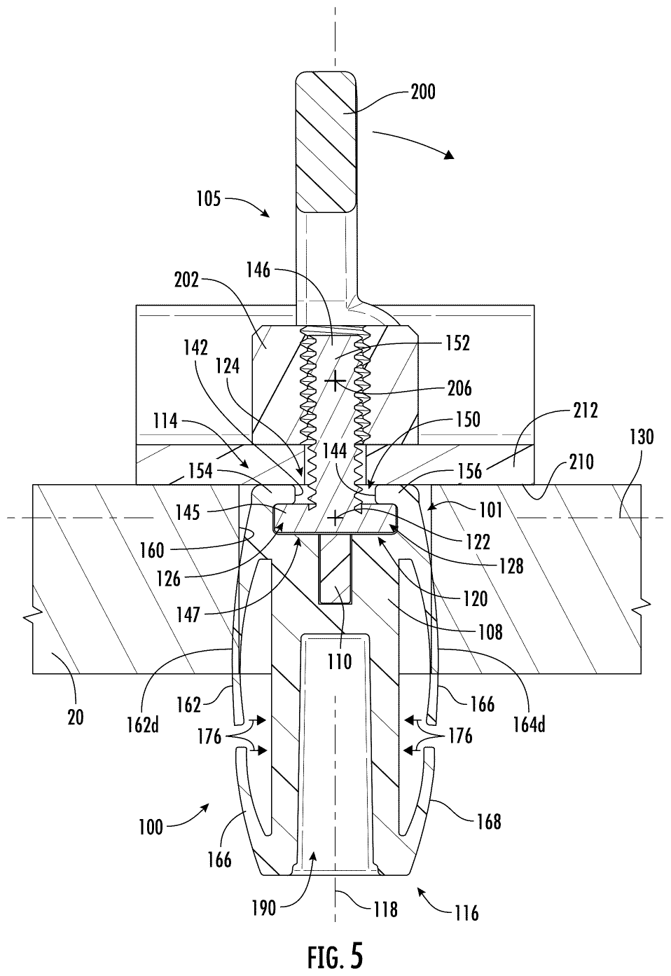

With reference to FIG. 5, this void region 147 receives the head portion 145 of an attachment member 146 that is used to secure a workpiece alignment component 105 to the bench dog adaptor 100. Portions of the head portion 145 extend into the undercut regions 126, 128 such that the head portion 145 is secured within the mounting slot 120 along longitudinal axis 118. However, the head portion 145 is permitted to slide laterally along the first transverse axis 122.

The mouth region 124 is similarly a substantially rectangular void region 150 (also referred to as a shaft void region 150). The shaft void region 150 is generally formed between mouth walls 142, 144. Shaft void region 150 is generally centered on head void region 147 relative to second transverse axis 130 but is offset from the head void region 147 along longitudinal axis 118.

The mouth region 124 and corresponding shaft void region 150 are sized smaller than the head void region 147 and are sized to allow a shaft portion 152 of the attachment member 146 to extend axially therethrough generally parallel to longitudinal axis 118 so that the shaft portion 152 can connect to other portions of the workpiece alignment component 105.

Distal ends of first and second flange portions 154, 156 provide mouth walls 142, 144, respectively. The distal ends face one another parallel to axis 130. The first and second flange portions 154, 156 also provide retaining walls 138, 140, respectively.

In this example, the flange portions 154, 156 are formed in a cantilevered orientation relative to undercut walls 132, 134.

The head void region 147 and shaft void region 150 form a continuous void region that defines the mounting slot 120 that receives the attachment member 146. The slot 120 prevents removal of the attachment member parallel to axis 118 but allows for sliding action (at least when in a released state) along first transverse axis 122.

To increase the securement of the bench dog adaptor 100 within an dog hole 101, the bench dog adaptor 100 includes a mounting portion. The mounting portion is configured to engage the workbench 20.

In this example, the mounting portion is a spring portion configured to resiliently radially engage dog hole sidewall 160 using a friction fit to secure the adaptor 100 within the dog hole 101 along axis 118. In this example, as the adaptor 100 is pushed axially into the dog hole 101 the spring portion flexes radially inward creating radially outward direction pressure on sidewall 160.

In this example, the mounting portion includes six spring portions 162, 164, 166, 168, 170, 172. First-fourth spring portions 162, 164, 166, 168 are formed as a continuous piece of material with first body portion 108 and the fifth and sixth spring portions 170, 172 are formed as a continuous piece of material with second body portion 110.

The spring portions 162, 164, 166, 168, 170, 172 generally include wing portions 162a, 164a, 166a, 168a, 170a, 172a that are connected to the corresponding first or second body portion 108, 110 by connection portions 162b, 164b, 166b, 168b, 170b, 172b. The wing portions 162a, 164a, 166a, 168a, 170a, 172a have free ends 162c, 164c, 166c, 168c, 170c, 172c.

Wing portions 162a, 164a, 170a, 172a generally extend from the corresponding connection portions 162b, 164b, 170b, 172b towards second end 116 such that free ends 162c, 164c, 170c, 172c are closer to the second end 116 than connection portions 162b, 164b, 170b, 172b.

Wing portions 166a, 168a extend in the opposite direction parallel to axis 118 as wing portions 162b, 164b, 170b, 172b. As such, free ends 166c, 168c are positioned closer to the first end 114 than connection portions 166b, 168b.

The wing portions 162a, 164a, 166a, 168a, 170a, 172a generally include a first portion beginning proximate the connection portion 162b, 164b, 166b, 168b, 170b, 172b and extending towards the free end 162c, 164c, 166c, 168c, 170c, 172c that tapers radially outward when moving away from the corresponding 162b, 164b, 166b, 168b, 170b, 172b (i.e. the outer surface of the wing portion becomes spaced radially farther from axis 118 when moving away from the corresponding connection portion). However, the wing portion 162a, 164a, 166a, 168a, 170a, 172a includes a second portion that changes its taper such that the free ends 162c, 164c, 166c, 168c, 170c, 172c are formed by portions that are either generally parallel to longitudinal axis 118 or taper radially inward towards longitudinal axis 118 (e.g. the outer surface of the wing portion becomes spaced radially closer to the axis 118 when moving away from the connection portion towards the free end). This arrangement allows for the free ends to pass by edges of the workbench where the dog hole walls 160 intersect the workpiece support surface 103.

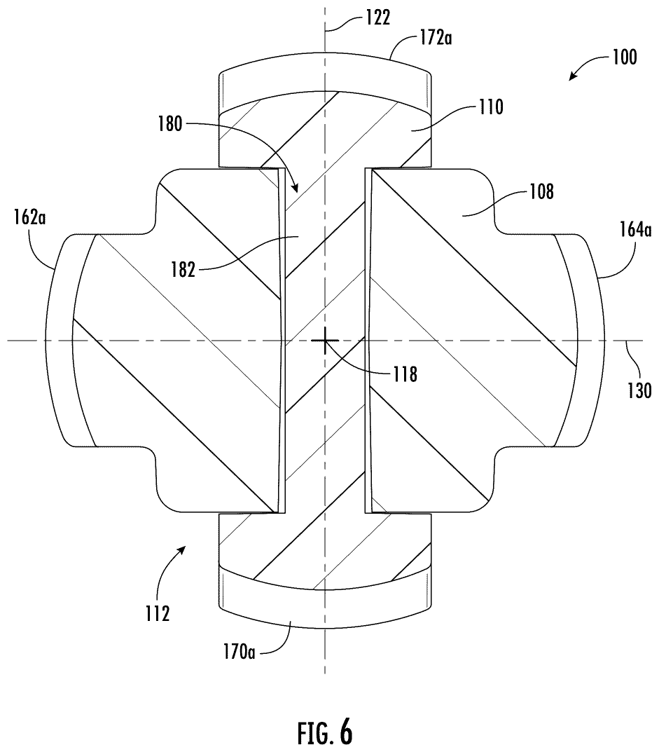

Wing portions 162a, 164a, 170a, 172a, in this example, are generally axially aligned at a same location along the longitudinal axis 118 but are angularly spaced about the longitudinal axis 118 (see e.g. FIGS. 4 and 6).

In this example, wing portions 162a, 166a are generally angularly aligned about axis 118 and located on a same first side of the elongated body portion 112 and wing portions 164a, 168 are generally angularly aligned about axis 118 and located on a same second side of the elongated body portion 112, e.g. 180 degrees about axis 118 from wing portions 162a, 166a. Wing portions 170a, 172 are generally angular aligned about axis 118 and at a same axial location along axis 118.

In this example, wing portions 170a, 172a, are angularly interposed between wing portions 162a, 164a, 166a, 168a about axis 118.

In this example, wing portions 162a, 164a, 170a, 172a are axially spaced along axis 118 relative to wing portions 166a, 168a such that the entirety of wing portions 162a, 164a, 170a, 172a are located axially closer to the first end 114 than the entirety of wing portions 166a, 168a.

Free ends 162c, 164c, 166c, 168c, 170c, 172c area spaced radially outward from elongated body portion 112 forming radial gaps 174 therebetween. This radial gap allows the wing portions 162a, 164a, 166a, 168a, 170a, 172a to resiliently flex radially inward (illustrated by arrows 176 in FIGS. 4 and 5) when inserted into the dog holes 101. Notably, the resilient flexing of the wing portions 162a, 164a, is not illustrated in FIG. 5 as the wing portions 162a, 164a, are illustrated overlapping the workbench 20. However, in operation, the outer surfaces 162d, 164d, of the wing portions 162a, 164a, would simply press radially against dog hole wall 160.

In this example, as the adaptor 100 is inserted into the dog hole 101, wing portions 166a, 168a flex towards one another, wing portions 162a, 164a flex towards one another and wing portions 170a, 172a flex towards one another. When removed, the wing portions flex radially outward to a relaxed state.

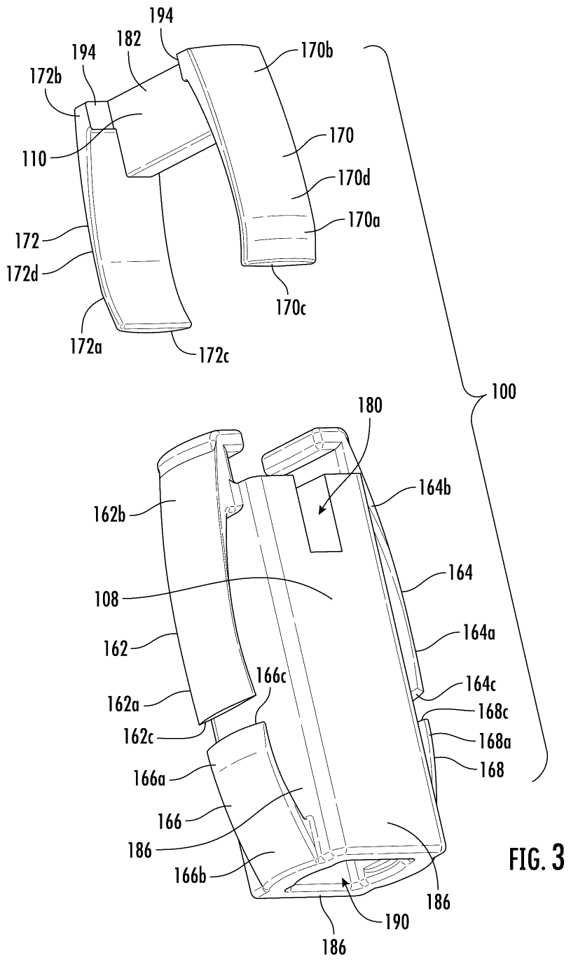

In this example, the elongated body portion 112 is formed from first and second body portions 108 and 110. With reference to FIGS. 3-6, the first body portion 108 defines an attachment slot 180 formed proximate first end 118. The second body portion 110 includes a mounting wall 182 sized to be inserted into the attachment slot 180 preferably with a friction fit such that the two body portions 108, 110 do not move relative to one another once assembled and are not easily separated, e.g. the first and second body portions 108, 110 would separate under the force of gravity.

A mouth of the attachment slot 180 opens towards first end 114 as well as mounting slot 120. In this particular embodiment, with the second body portion 110 removed, the attachment slot 180 connects to mounting slot 120 forming a continuous void region. Thus, to mount the second body portion 110 to the first body portion mounting wall 182 passes through mouth 124 and mounting slot 120 on its way into attachment slot 180.

The outer periphery of the elongated body portion 112, generally defined in this example by the first body portion 108, has a generally rectangular periphery with a plurality of flat regions 186 angularly about axis 118.

The second body portion 110 includes locating abutments 194 that contact opposed flat regions 186 of the first body portion 108. This prevents the second body portion 110 from moving parallel to axis 122 within attachment slot 180. Here, the locating abutments 194 that abut one flat region 186 face opposed locating abutments 194 that abut the opposed flat region 186.

The wing portions 162a, 164a, 166a, 168a, 170a, 172a angularly align with the flat regions 186 about axis 118.

Rounded corners that provide a curved outer surface connect angularly adjacent flat regions 186.

The attachment slot is generally defined by opposed walls 184, 186 and bottom wall 188 extending laterally therebetween.

From a top view, such as illustrated in FIG. 6, the outer surface of wing portions 162a, 164a, 166a, 168a, 170a, 172a may have a curved profile extending, in part angularly about axis 118. This facilitates insertion of the bench dog adaptor 100 into round dog holes 101.

The elongated body portion 112 is generally tubular along a majority of its axial length along axis 118. In this example, the internal cavity 190 of the tube has a generally rectangular cross-section orthogonal to longitudinal axis 118. Here, the elongated body portion 112 has its internal cavity 190 closed proximate the first end and open proximate the second end 116. Further, the cross-sectional area of the internal cavity 190 that is orthogonal to axis 118 increases when moving along axis 118 away from the first end 114 towards the second end 116.

In some implementations, the length of the wing portions 162a, 164a, 166a, 168a, 170a, 172a is such that wing portions 162a, 164a, 170a, 172a remain, at least in part, received within the dog holes 101 while wing portions 166a, 168a are fully removed from the dog holes 101 when the bench dog adaptor 100 is inserted into the dog holes 101. In such an arrangement, the wing portions 166a, 168a would be in a relaxed state while wing portions 162a, 164a, 170a, 172a would be flexed radially inward providing a friction engagement.

However, with wing portions 166a, 168a relaxed and thus flexed back radially outward once passing through the dog hole 101, the free ends 166c, 16bc can provide an interference fit inhibiting removal of the bench dog adaptor 100 from the dog holes 101 and the workbench 20. The user may be required to press these wing portions 166a, 168a radially towards one another to remove the bench dog adaptor 100 from the workbench. This is illustrated by the middle bench dog adaptor illustrated in FIG. 1.

However, in other arrangements the tapered configuration of the ends 166c, 168c could be configured to cause these wing portions 166a, 168a to flex radially inward simply by pulling axially on the bench dog adaptor 100 parallel to axis 118 to remove the bench dog adaptor 100 from the dog hole 101.

In this example, wing portions 162a, 164a, 170a, 172a extend axially parallel to axis 118 a greater length than wing portions 166a, 168a. In particular, wing portions 162a, 164a, 170a, 172a have a same first length and wing portions 166a, 168a have a same second length that is shorter than the first length.

In one example, the wing portions 162a, 164a, 170a, 172a have an outward facing engagement surface configured to radially engage the dog hole wall 160 of the dog hole 101 when installed therein. A first maximum radial dimension measured perpendicular to the longitudinal axis 118 to the engagement surface of the wing portions 162a, 164a, 170a, 172a is greater than a second maximum radial dimension measured perpendicular to the longitudinal axis to the engagement surface of the wing portions 166a, 168a, when all wing portions 162a, 164a, 166a, 168a, 170a, 172a are all in a relaxed state.

In other embodiments, more or fewer wing portions could be provided. Further, in other embodiments, the elongated body portion could be formed from a single continuous piece of material.

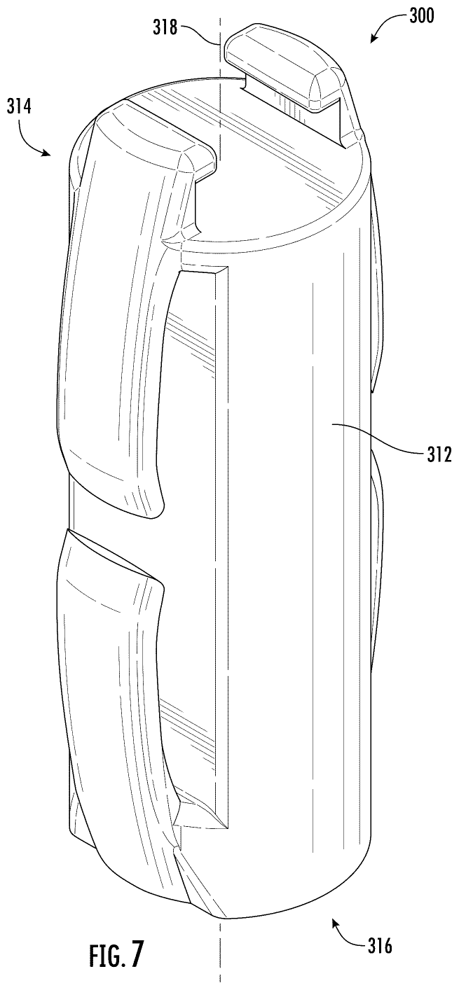

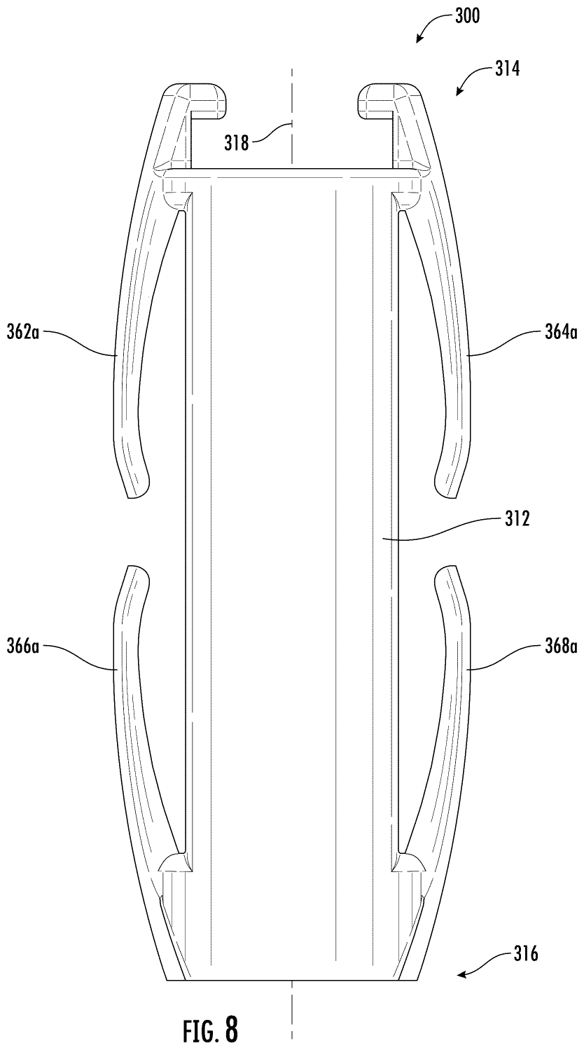

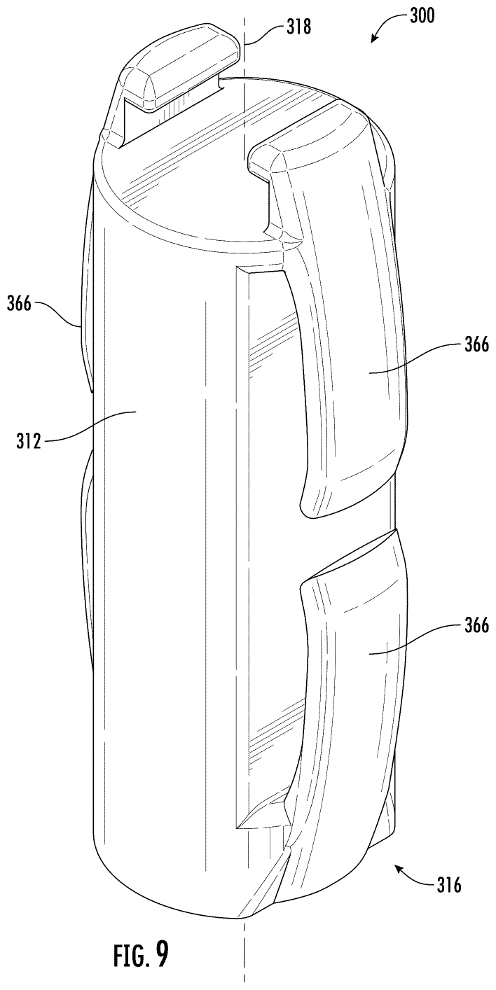

FIGS. 7-9 illustrate an alternative embodiment where the bench dog adaptor 300 is formed from a single continuous piece of material. Here, the wing portions 362a, 364a, 366a, 368a are formed continuously with elongated body portion 312. In this example, there are only four wing portion 362a, 364a, 366a, 368a on only two sides of the elongated body portion 312. Further, the wing portions 362a, 364a, 366a, 368a extend axially parallel to axis 108 a same length as compared to the prior example, where wing portions 162a, 164a, 170a, 172a extend a longer length than wing portions 166a, 168a.

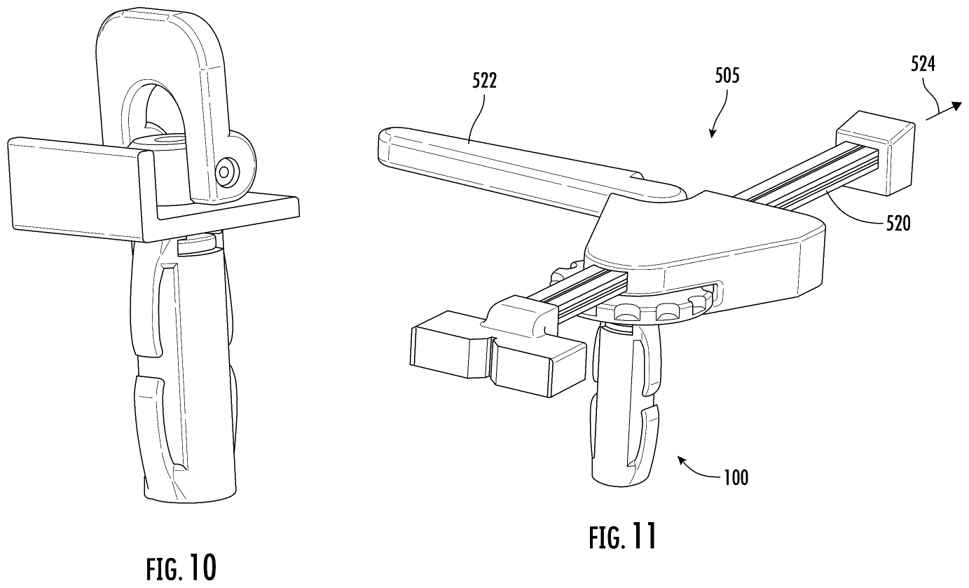

FIGS. 1, 5 and 10 illustrate the bench dog adaptor 100 connected to a workpiece alignment component 105 in the form of a stop member that can be positioned adjacent a side of a workpiece.

With reference to FIG. 5, the workpiece alignment component 105 includes attachment member 146 which takes the form of a T-bolt that has a head portion 145 and shaft portion 152 as outlined above. The head portion 145 secures the T-bolt to the bench dog adaptor 100 while the shaft portion 152 attaches to the rest of the workpiece alignment component 105.

In this example, a cam handle 200 attaches to a nut member 202 that is threadedly attached to the shaft 152. The cam handle 200 has cam surfaces 204 and can be pivoted relative to the nut member 202 about axis 206 to pull the T-bolt 146 away from second end 116 along axis 118. This can pull the first end 114 of the adaptor 100 against the workpiece alignment member 105.

In this example, first end 114 is biased against a bottom surface 210 of abutment member 212 of the workpiece alignment component 105. The cam handle 200 pivots about axis 206, as illustrated by arrow 214, between an engaged position and a released position. Cam handle 200 s illustrated in the released position in FIGS. 1 and 5.

In the engaged position, the cam handle 200 applies a first amount of biasing force on the shaft 152 and head 145 such that the first end 116 of the elongated body portion 112 is biased against bottom surface 210 with at least a first amount of biasing force. In the released position, the cam handle 200 applies no biasing force biasing the first end 114 of the elongate body portion 112 against bottom surface 210 or a second amount of biasing force that is less than the first amount of biasing force is applied.

In other examples, a knob or nut arrangement could be provided that is attached to shaft 152. The workpiece alignment component is thus secured to or released from the bench dog adaptor 100 simply by rotating the knob or nut about axis 118.

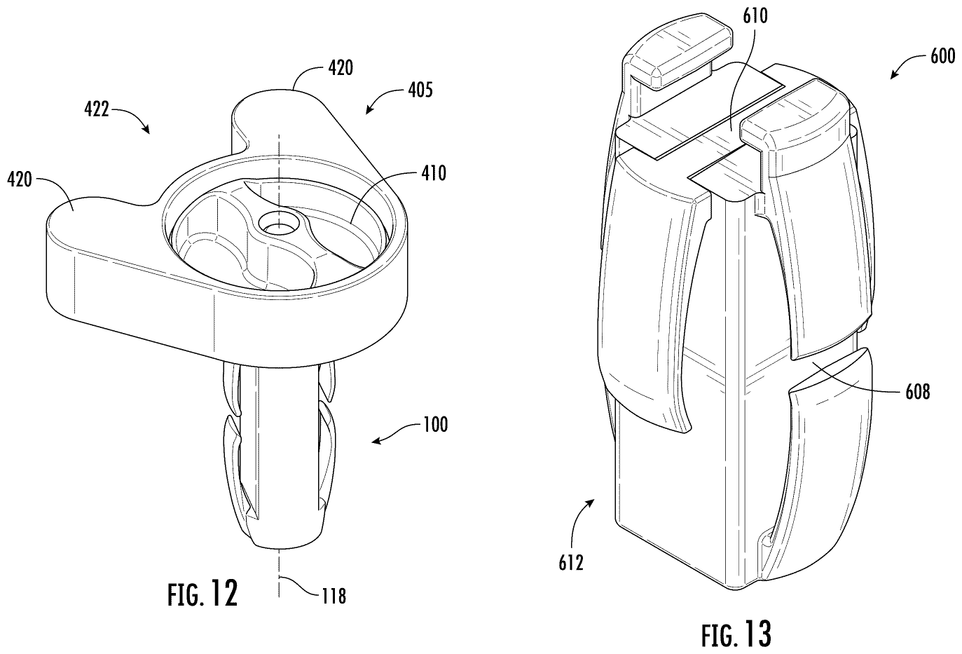

FIG. 12 illustrates a workpiece alignment component 405 that includes such a knob 410.

FIG. 11 illustrates a further workpiece alignment component 505 in the form of a lateral clamp attached to a bench dog adaptor 100. A user may use the combination of workpiece alignment components to secure a workpiece to the workbench 20. For example, a workpiece could be positioned between workpiece alignment component 105 and workpiece alignment component 505 where the user uses component 505 to produce a clamping force to press the workpiece into the abutment member 212 of workpiece alignment component 105.

Component 505 includes a clamp arm 520 that can be actuated using handle 522 to create clamping force. The clamping force is illustrated by arrow 524 in FIG. 11.

Workpiece alignment component 405 can be used with workpieces having a convex curved side. The rounded side can be located between ear portions 420 of abutment member 421 with the rounded side projecting into cavity 422 formed angularly between ear portions 420. Further the curved side 426 of the abutment member 421 can provide a point/line contact against a workpiece. This can be useful for workpieces with a concave curved side.

In some examples, when mounted to the workbench 20 using the bench dog adaptor 100, the workpiece alignment components and particularly the abutment members thereof are free to rotate about axis 118 so that they can be properly oriented relative to the workbench 20 and workpiece.

While the illustrated workpiece alignment components generally illustrate ways to laterally locate the workpiece relative to the workbench 20, other examples could provide clamping forces for securing a workpiece against surface 103 of the workbench 20.

Thus, as can be illustrated, the use of the bench dog adaptors herein various workpiece alignment components can be easily mounted to the workbench.

FIGS. 13-15 illustrate a further example of a bench dog adaptor 600. The bench dog adaptor 600 is similar in many respects as the prior bench dog adaptor and includes first and second body portions 608, 610 that form elongated body portion 612 that has first and second ends 614, 616.

Like bench dog adaptor 100, adaptor 600 includes six attachment portions in the form of spring portions 662, 664, 666, 668, 670, 672 that have wing portions 662a, 664a, 666a, 668a, 670a, 672a that are connected to the corresponding body portion 608, 610 by connection portions 662b, 664b, 666b, 668b, 670b, 672b.

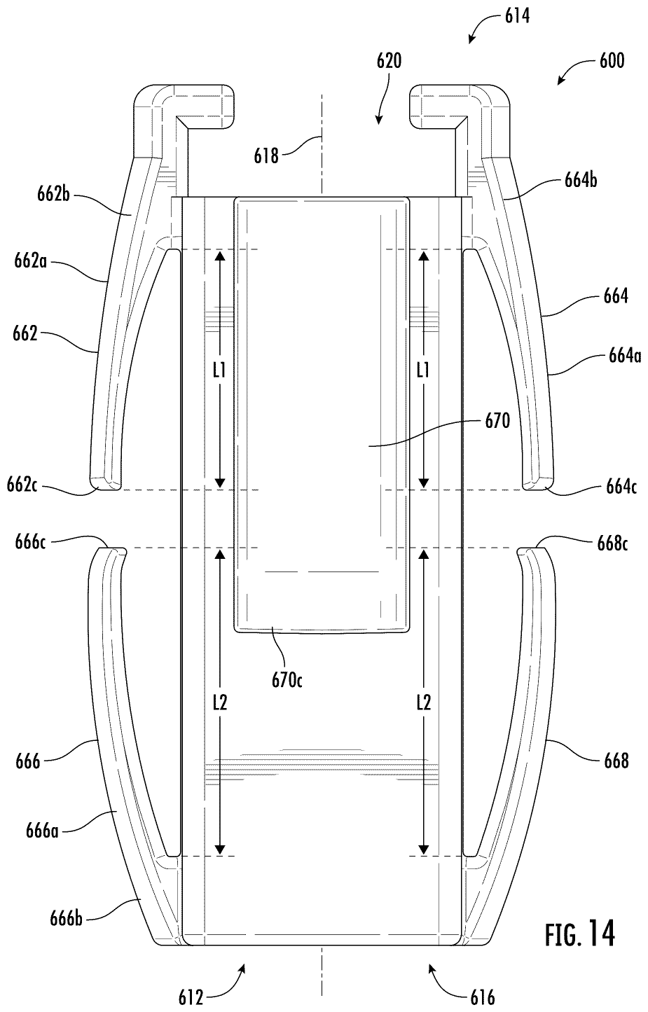

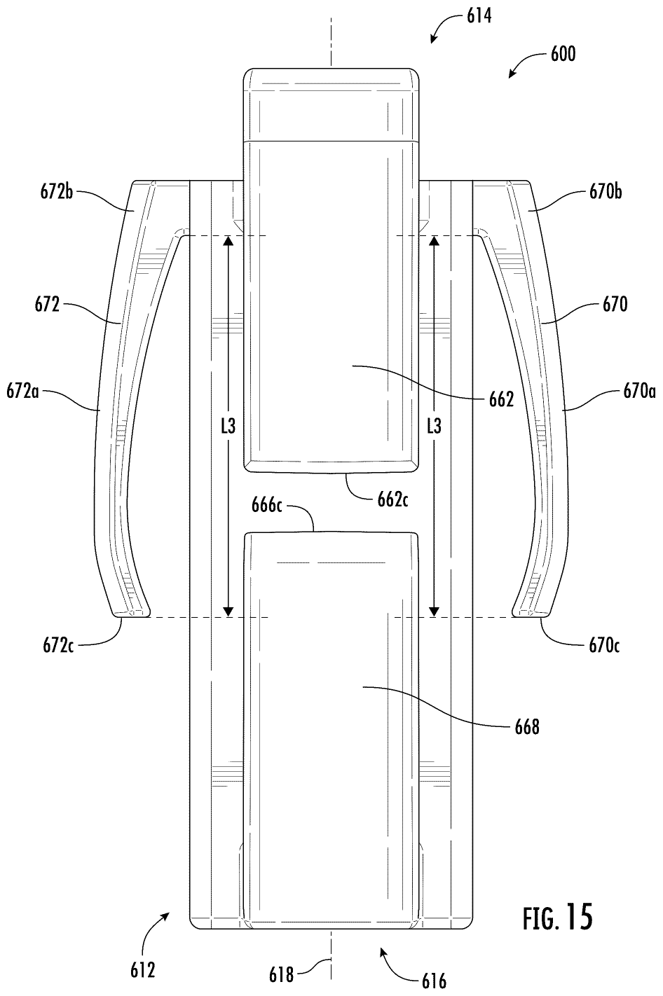

Wing portions 662a, 664a, 666a, 668a, 670a, 672a have a length parallel to longitudinal axis 618 from the connection portions 662b, 664b, 666b, 668b, 670b, 672b to distal ends 662c, 664c, 666c, 668c, 670c, 672c. Wing portions 662a, 664a have length L1 (see FIG. 14). Wing portions 666a, 668a have length L2 (see FIG. 14). Wing portions 670a, 672a have length L3 (see FIG. 15). In this example, length L3 is greater than length L1. Length L2 is greater than length L1. Length L3 is greater than length L2.

Because of this arrangement, free ends 662c, 664c are closest to first end 614. However, free ends 670c, 672c which are free ends of wing portions 670a, 672a that extend in the same directly as wing portions 662a, 664a are farthest from first end 614 and are closes to second end 616. Free ends 666c, 668c are axially interposed between free ends 662c, 664c and free ends 670c, 672c along axis 618.

Thus, the various examples of the bench dog adaptors 100, 300, 600 illustrate that different mounting portion configurations (e.g wing portion configurations) may be incorporated.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bench dog adaptor comprising:
an elongated body portion having a first end a second end, the body portion having an outer periphery extending between the first and second ends, the body portion having a longitudinal axis extending through the first and second ends, at least one of the first and second ends having a mounting slot extending along a first transverse axis that is generally perpendicular to the longitudinal axis, the mounting slot has a mouth region and spaced apart first and second undercut regions, a first width of the mouth region parallel to a second transverse axis being less than a second width parallel to the second transverse axis from the outer most extents of the first and second undercut regions, the second transverse axis being generally perpendicular to the first transverse axis;
at least one first mounting portion configured to resiliently radially engage a sidewall of a dog hole formed in a workbench to secure the body portion within the dog hole.

2. The bench dog adaptor of claim 1, wherein the first mounting portion is a spring portion configured to resiliently flex radially inward towards the elongated body when inserted into a dog hole in a workbench.

3. The bench dog adaptor of claim 1, wherein the first mounting slot has a T-shaped cross-section.

4. The bench dog adaptor of claim 3, wherein the first and second undercut regions are formed by a continuous rectangular void portion having a generally rectangular profile, the mouth region being generally centered along the second transverse axis relative to the single continuous void, the mouth region being offset from the rectangular profile along the longitudinal axis, the mouth region and continuous rectangular void forming a single continuous void; and
wherein the mouth region is a substantially rectangular void portion having a generally rectangular profile.

5. (canceled)

6. The bench dog adaptor of claim 1, wherein the mouth region is formed between spaced apart laterally inward extending first and second flange portions, the first flange portion spaced apart from the second flange portion parallel to the second transverse axis;
the first flange portion defining in part the first undercut region; and
the second flange portion defining in part the second undercut region.

7. (canceled)

8. The bench dog adaptor of claim 2, wherein the spring portion is formed as a continuous piece of material with the elongated body portion.

9. The bench dog adaptor of claim 2, wherein:
the mounting slot is formed at the first end, the spring portion has an elongated first wing portion that extends from a connection portion wherein the first wing portion is connected to the elongated body portion to a free end, the free end of the first wing portion being closer to the second end of the elongated body portion than the first end of the body portion along the longitudinal axis;
the free end is spaced radially outward from an outer periphery of the elongated body portion forming a radial gap therebetween; and
the first wing portion includes a radially outward tapering outer surface that tapers radially outward from the longitudinal axis when moving along the longitudinal axis in a direction extending from the first end towards the second end.

10-11. (canceled)

12. The bench dog adaptor of claim 9, wherein the free end of the first wing portion is formed by a tapered region that extends radially inward towards the elongated body portion relative to a radially outer most extent of the radially outward tapering outer surface of the first wing portion.

13. The bench dog adaptor of claim 9, further comprising a second mounting portion in the form of a second wing portion on an opposite side of the elongated body portion being substantially identical to the first wing portion.

14. The bench dog adaptor of claim 13, wherein;
the second wing portion is connected to the elongated body portion at a same axial location along the longitudinal axis as the first wing portion and a free end of the second wing portion is positioned at a same axial location long the longitudinal axis as the free end of the first wing portion
the free ends of the first and second wing portions are resiliently flexible towards one another to allow for insertion into the dog hole and to provide radially outward directed engagement of the first and second wing portions with the dog hole.

15. (canceled)

16. The bench dog adaptor of claim 14, further including third and fourth mounting portions in the form of third and fourth wing portions, the third and fourth wing portions being connected to the elongated body portion proximate the second end and extending towards the first end of the elongated body portion and terminating in free ends.

17. The bench dog adaptor of claim 16, wherein the first wing portion is angularly aligned about the longitudinal axis with the third wing portion and the second wing portion is angularly aligned about the longitudinal axis with the fourth wing portion.

18. The bench dog adaptor of claim 1, wherein the mounting slot is formed at the first end of the elongated body portion, wherein the elongated body portion has a tubular portion extending axially between the first and second ends, the tubular portion being closed proximate the first end and open proximate the second end.

19-22. (canceled)

23. The bench dog adaptor of claim 18, wherein the tubular portion defines an internal cavity, the internal cavity increasing in cross-sectional area when moving from the first end towards the second end, the cross-sectional area being measured orthogonal to the longitudinal axis.

24. The bench dog adaptor of claim 1, wherein the radial engagement of the first mounting portion with the dog hole provides frictional engagement to resist removal of the elongated body portion from the dog hole.

25. The bench dog adaptor of claim 16, wherein the first and second wing portions extend parallel to the longitudinal axis a first length and the third and fourth wing portions extend parallel to the longitudinal axis a second length, the second length being less than the first length.

26. The bench dog adaptor of claim 16, further including fifth and sixth mounting portions in the form of fifth and sixth wing portions, the fifth and sixth wing portions being connected to the elongated body portion proximate the first end and extending towards the second end of the elongated body portion and terminating in free ends.

27-28. (canceled)

29. The bench dog adaptor of claim 26, wherein the elongated body portion is formed from a first body portion and a second body portion attached to the first body portion, the first and second wing portions are formed as a continuous piece of material with the first body portion and the fifth and sixth wing portions are formed as a continuous piece of material with the second body portion.

30. The bench dog adaptor of claim 29, wherein one of the first body portion or second body portion includes an attachment slot opening towards the first end and the other one of the first body portion or second body portion includes a mounting wall, the mounting wall extending into the attachment slot when the first and second body portions are attached to one another.

31-33. (canceled)

34. The bench dog adaptor of claim 16, wherein each of the first, second, third and fourth wing portions have an outward facing engagement surface configured to radially engage the sidewall of the dog hole when installed therein, a first maximum radial dimension measured perpendicular to the longitudinal axis to the engagement surface of the first and second wing portions is greater than a second maximum radial dimension measured perpendicular to the longitudinal axis to the engagement surface of the third and fourth wing portions, when the first, second, third and fourth wing portions are in a relaxed state.

35. A workbench workpiece alignment assembly for positioning a workpiece on a workbench comprising:
a bench dog adaptor of claim 1;
a workpiece alignment component comprising:
a workpiece alignment member configured to engage a workpiece on the workbench;
an attachment member connected to the workpiece alignment member, the attachment member having a head configured to extend into undercut regions of the mounting slot of the bench dog adaptor and a shaft extending from the head that is sized to extend through the mouth region of the mounting slot to secure the workpiece alignment member to the bench dog adaptor.

36. (canceled)

37. The workbench workpiece alignment assembly of claim 35, wherein:
the attachment member includes a cam member that has a released position and an engaged position;
in the engaged position, the cam member applies a first amount of biasing force on the shaft and head such that the first end of the elongated body is biased against the workpiece alignment member with at least a first amount of biasing force;
in the released position, the cam member applies no biasing force biasing the first end of the elongate body against the workpiece alignment member or a second amount of biasing force that is less than the first amount of biasing force.
